(19) United States
(12) Patent Application Publication
(10) Pub. No.: US 2005/0288978 A1
(43) Pub. Date: Dec. 29, 2005

(54) METHOD FOR SUPPLY AND DEMAND CHAIN INTEGRATION OF TEST DATA

(75) Inventors: Thomas D. Furland, Essex Junction, VT (US); William W. Gile, Colchester, VT (US); Michael J. Hyder, Jericho, VT (US); Jayakumar Krishnamurthy, Framingham, MA (US); Lewis C. Martin, Essex Junction, VT (US); Muthukrishnan Vishwanathan, South Burlington, VT (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: INTERNATIONAL BUSINESS MACHINES CORPORATION, Armonk, NY (US)

(21) Appl. No.: 10/710,252

(22) Filed: Jun. 29, 2004

(51) Int. Cl. G06Q 10/00; G06Q 99/00

(52) U.S. Cl. 705/7; 705/1

(57) ABSTRACT

Disclosed is a method/system for transferring test data from a supply chain to a demand chain. This process includes performing a supply side reconciliation of the test data and a demand side reconciliation of the test data upon the occurrence of a trigger event in the supply chain. Then, the invention processes this reconciled data through a business rules database to process entitled test data for correctness, and verifies that the entitled data is supplied to selective points in the demand chain.

### BACKGROUND OF INVENTION

1. Field of the Invention

The invention generally relates to a method of transferring test data from a supply chain to a demand chain, and more particularly to a method/system that performs supply side and demand side reconciliations of the test data upon the occurrence of a trigger event in the supply chain, and processes this reconciled data through a business rules database to verify that entitled test data is selectively supplied to points in the demand chain.

2. Description of the Related Art

For purposes of this application, the following definitions will be used. A “supplier” is an entity outside a manufacturer where or one more manufacturing steps are completed and where components of devices are produced. “Manufacturers” produce a product or device. One or more steps (components) in this manufacturing process can be performed by an external supplier and in some cases all manufacturing steps can be performed by the supplier. The “customer” is an entity which buys products (devices) from the manufacturer.

In the multi-step manufacturing process, data can originate for the same product from multiple sources, internal to a company or external. For example, manufacturing step A could be at location A, and step B could be at location B. In a multi-source manufacturing process, data for a given step, itself, could originate from different sources. Manufacturing step C of the product could be done within the company or an external supplier.

During the manufacturing process, customers may be entitled to see different types and levels of data. For example, in multi-step, multi-source manufacturing, different data may be associated with each product at each step of manufacturing. In addition, across different organizations, the customers may be tracked by different product codes and/or classifications. Some challenges that arise when sending data to the customer are completeness and timeliness of the data.

### SUMMARY OF INVENTION

The invention provides a method of transferring test data from a supply chain to a demand chain. This process includes performing a supply side reconciliation of the test data and a demand side reconciliation of the test data upon the occurrence of a trigger event in the supply chain. Then, the invention processes this reconciled data through a business rules database to verify that entitled test data is selectively supplied to points in the demand chain.

This supply side reconciliation process reconciles data from the trigger event with the test data. For example, the trigger event can be a notification of goods being sent from a point in the supply chain, and the supply side reconciliation would determine whether test data associated with the goods is consistent with the notification of shipment. The demand side reconciliation determines whether the test data is complete and has been send to the demand chain. Further, these processes of performing the supply side reconciliation and the demand side reconciliation can be selectively delayed or accelerated (advanced) a predetermined period after or before the trigger event.

One of the benefits of the invention is that the process of supplying the entitled test data supplies component test data after the component is completed, but before the device of which the component is a part is completed. Further, during the supply side and demand side reconciliation processes, the test data is corrected if it does not initially reconcile with the trigger event data. This provides the customer with accurate (potentially corrected) test and shipping data of the device components as they are shipped from suppliers, which is well in advance of receipt of the completed device. Another benefit of the invention is the ability to pro-actively detect problems in the data, thereby providing time to correct it prior to the point when data is needed to be sent to the demand chain.

A system embodiment of the invention includes a trigger event monitor, a supply side reconciler in communication with the trigger event monitor, and being adapted to perform a supply side reconciliation of the test data upon the occurrence of a trigger event. A demand side reconciler is also in communication with the trigger event monitor, and is adapted to perform a demand side reconciliation of the test data upon the occurrence of the trigger event. Further, a rules database that is in communication with the supply side reconciler and the demand side reconciler, is adapted to process entitlement test data based on the supply side reconciliation and the demand side reconciliation and to verify that the entitled test data is supplied selectively to points in the demand chain.

In this system the supply side reconciliation process performed by the supply side reconciler reconciles data from the trigger event with the test data. Similarly, the demand side reconciliation process performed by the demand side reconciler comprises determining whether the test data is complete and whether it has been sent to the demand chain. Again, these processes of performing the supply side reconciliation and the demand side reconciliation can be selectively delayed or accelerated a predetermined period after or before the trigger event by the supply side reconciler and the demand side reconciler.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF DRAWINGS

The invention will be better understood from the following detailed description with reference to the drawings, in which:

FIG. 1 is a schematic diagram illustrating production flow;

FIG. 2 is a schematic diagram illustrating production flow;

FIG. 3 is a schematic diagram showing the relationship between suppliers, a company and customers;

FIG. 4 is a flow diagram illustrating one embodiment of the invention;

FIG. 5 is a schematic diagram of the inventive system;

FIG. 6 is a schematic diagram showing the delay of the trigger point; and

FIG. 7 is a schematic diagram showing the delay of the trigger point.

### DETAILED DESCRIPTION

The present invention and the various features and advantageous details thereof are explained more fully with reference to the nonlimiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

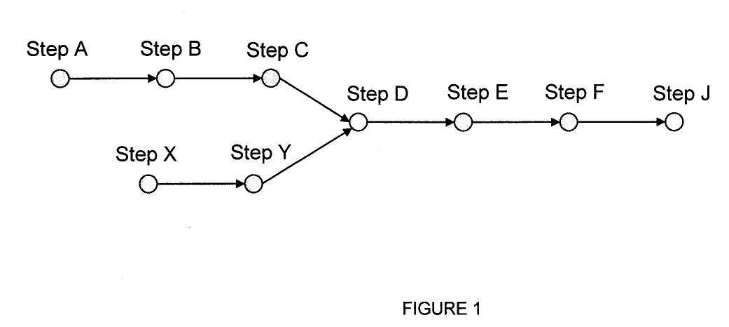

As mentioned above, with multi-step, multi-source manufacturing environments it is difficult to provide timely, accurate data on components being manufactured for customers. One example of a production flow is shown in FIG. 1. In FIG. 1, steps A-C and steps X-Y can be performed in parallel. After these two portions of the supply chain are completed, then steps D-J can be performed sequentially to produce a given device. In this process, there are data attributes (e.g., test data, wafer map, quality data, yield data, etc.) at each step, and production lots can be split/merged, adding to the complexity.

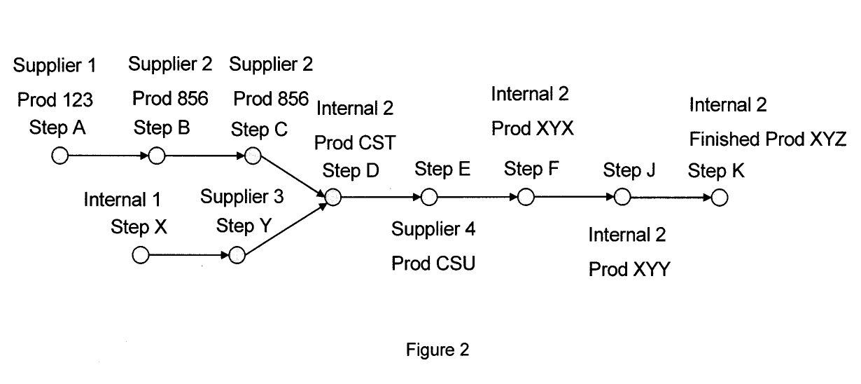

FIG. 2 illustrates a production flow with multi-step and multi-source manufacturing. More specifically, in FIG. 2, step A produces component 123 and this component is manufactured by Supplier 1. Supplier 2 performs steps B and C to produce component 856. Step X is performed internally by the manufacturer at Location 1, while Supplier 3 performs step Y. Again, component product CST is produced internally at Location 2. In step E, Supplier 4 produces component product CSU. Again at internal Location 2, product XYX is produced and component product XYY is produced in steps F and J. Finally, the finished product XYZ is produced in step K, again at internal Location 2. Again, there are data attributes at each step, increasing the possibility of different identification (like product code) at each step. Production lots can be split/merged, adding to the complexity. To provide data associated with the finished product (XYZ) it is necessary to look at the attributes of Product 123 from Supplier 1, Product 856 from Supplier 2, etc. The customers do not want to wait until step K to see data associated with step B, as shown in FIG. 2.

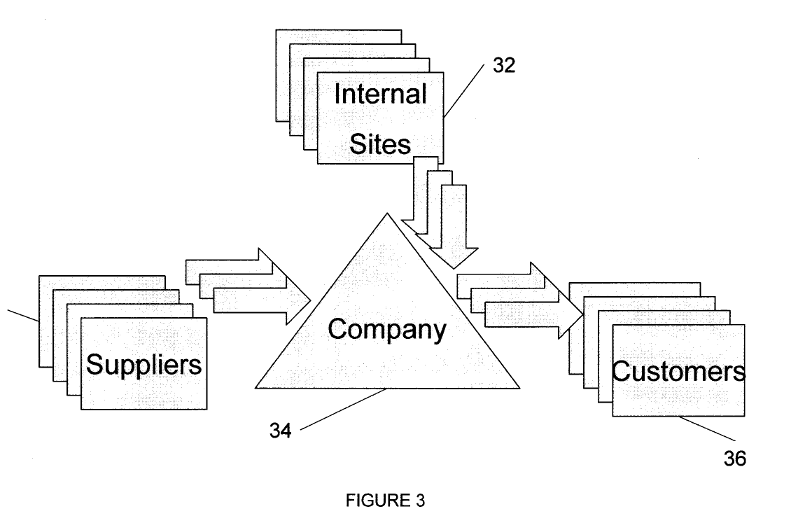

FIG. 3 illustrates the relationship between the manufacturing company 34, the suppliers 30, the internal sites 32 within the manufacturing company, and the customers 36. Some additional problems with multi-step and multisource manufacturing that are illustrated by FIG. 3 are whether the data can be identified in the supply chain (30, 32) by the manufacturer 34, whether all of the data was received by the customer 36, what action needs to be taken with respect to the data, whether a problem can be fixed before the customer 36 receives the data, etc.

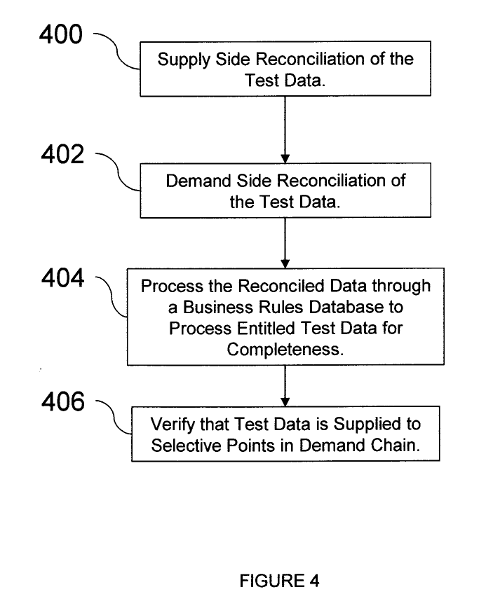

FIG. 4 shows one embodiment of the invention in flowchart form. As mentioned above, the invention provides a method of transferring test data from a supply chain (e.g, manufacturer 30, suppliers 32, internal sites 34, etc.) to a demand chain (e.g., customer 36). This process includes performing a supply side reconciliation of the test data 400 upon the occurrence of a trigger event, such as the shipment of a component, the expiration of a time period, etc. For example, the trigger event can be a notification of goods being sent from a point in the supply chain, and the supply side reconciliation would determine whether test data associated with the goods is consistent with the notification of shipment. This supply side reconciliation process 400 reconciles data from the trigger event with the test data.

Item 402 represents a demand side reconciliation of the test data upon the occurrence of the trigger event in the supply chain. The demand side reconciliation 402 determines whether the test data is complete and has been sent to the demand chain. Then, the invention processes this reconciled data through a business rules database to process entitled test data 404. This processing 404 checks the entitled test data for completeness. The invention verifies that the entitled test data is supplied to selective points in the demand chain in item 406. The processes of performing the supply side reconciliation and the demand side reconciliation can be selectively delayed or advanced a predetermined period after or before the trigger event.

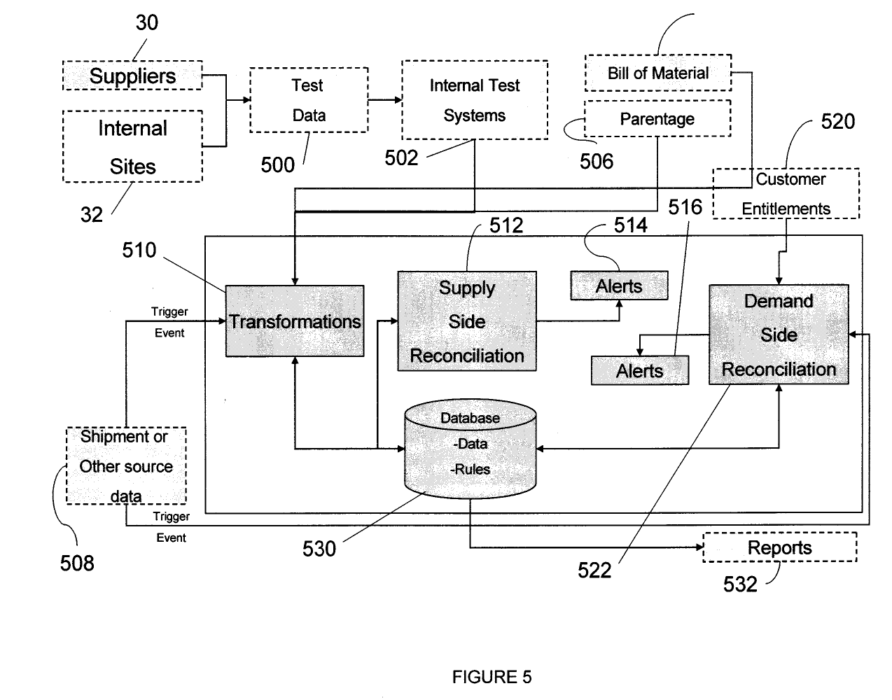

A system embodiment of the invention is shown in FIG. 5. The suppliers 30, and internal sites 32, discussed above, produce test data 500 as part of the component manufacturing process. This test data 500 is forwarded to internal test systems 502 within the manufacturing company. Item 504 represents a bill of materials database and item 506 represents information regarding the parentage (which is a relationship between the various devices and their associated components). The information from the internal test systems 502, the bill of materials 504, as well as the parentage information 506 is forwarded to the transformation unit 510, which transforms the test data 500 into appropriate categories as controlled by relationships between components and devices in the bill of materials 504 and parentage data 506. The bill of materials structure 504 is used as well as a parentage database 506 to provide manufacturing lot trace capability. The needed transformations are applied to the information received from attribute data streams 500, 502 (e.g., test data) and trigger (e.g., shipment) data 508. For example, the lot transformation uses the product parentage to identify and reconcile attributes of the data (e.g., test) and trigger (e.g., shipment), and the product transformation uses the bill of materials 504.

Item 520 represents the customer entitlements, which includes information as to what type of data each customer is entitled to receive, and on which type of products and components the customer is entitled to receive such information.

Item 508 represents a trigger event monitor which tracks shipment of components and other data (such as periodicity, etc.) that can comprise a trigger event. The shipment data 508 can be received from suppliers via the Internet or radio frequency identification (RFID) tags attached to a product or its packaging or other means. The invention defines rules that can be maintained in database 530 or in the trigger event monitor 508 regarding the trigger event. For example, the trigger can be an event, like shipments, from an external source or a trigger can be a schedule that checks and re-checks periodically (every hour).

Item 512 represents the supply side reconciler and item 522 is the demand side reconciler. The supply side reconciler 512 is adapted to perform a supply side reconciliation of the test data (transferred to the database 530 by the transformation unit 510) upon the occurrence of a trigger event received from the trigger event monitor 508. Once again, the supply side reconciler 512 reconciles the test data 500 with the data of the trigger event. The demand side reconciler 522 receives information on the customer entitlements 520 to perform a demand side reconciliation. One aspect of the invention is the database 530 of test data that is collected from suppliers 30 and internal systems 502 within a company. Thus, item 530 represents the database of data and rules that are used to produce the various reports 532 to the demand side, as controlled by the demand side reconciler 522.

In this system, the supply side reconciliation process performed by the supply side reconciler 512 reconciles data from the trigger event 508 with the test data 500. Similarly, the demand side reconciliation process performed by the demand side reconciler 522 determines whether the test data 500 is complete and whether the transformed (510) and supply side reconciled (512) data in the database 530 has been sent to the demand chain 532. Again, these processes of performing the supply side reconciliation and the demand side reconciliation can be selectively delayed or advanced predetermined period after or before the trigger event by the supply side reconciler 512 and the demand side reconciler 522.

In addition, configurable rules are stored in the database 530 regarding the allowed delay between the trigger event and the reconciliation span. Business rules are stored in the database 530 to define exceptions. Such rules can be extensive and can restrict data according to the Partner/Location, Class (e.g., technology), and Type (e.g., test type) level (example: Supplier X, New mm technology, Kerf test), etc.

In one example of supply side reconciliation, a supplier 30 will send a series of test data 500 at different manufacturing steps and then ship the product to a manufacturer. During this process, the shipment notification may have an error (e.g. all the lots shipped may not be in the notification). Alternatively, shipment and notification might have been received but the test data might not have been received. Further, the test data might have been received but shipment might not have been received within the appropriate delay window. Assuming that some manufacturing steps and tests were done at a supplier prior to the manufacturers work, the shipment notification may have some errors. For example, all of the lots shipped may not be in the notification, or the shipment may have been linked to the wrong supplier. In addition, the shipment and notification from the supplier might have been received, but the test data might not have. In view of the foregoing, the supply side reconciler 512 produces reconciliation metrics regarding the percentage of errors in shipment notification, the percentage match of shipments vs. test data received, etc.

With respect to demand side reconciliation 522, some customers are entitled to receive certain test data for a product in a multi-step, multi-sourced manufacturing environment. When this occurs, all of the entitled test data may not be available or the data may have been received but might not have been sent to the customer. In the demand side reconciliation, as above, metrics such as the percentage match of trigger event (shipment received) vs. entitled attribute data sent to the customer, etc. is generated by the demand side reconciler 522.

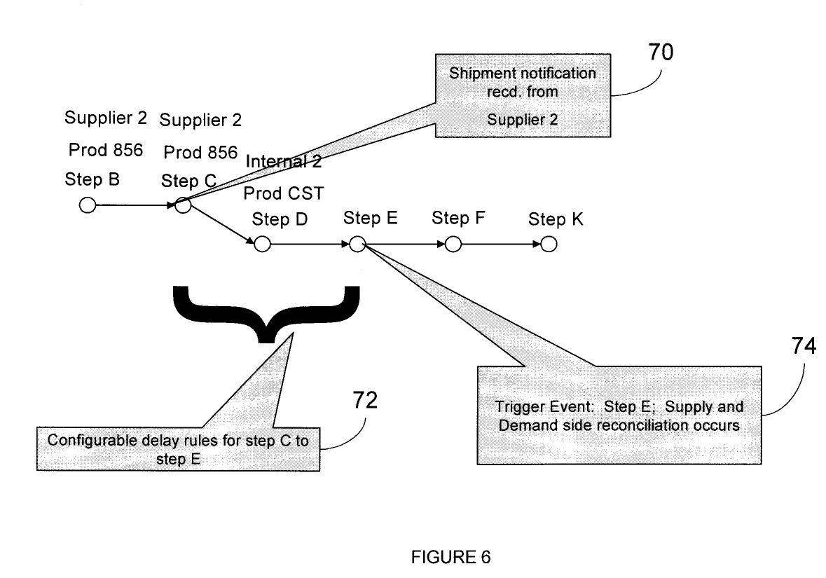

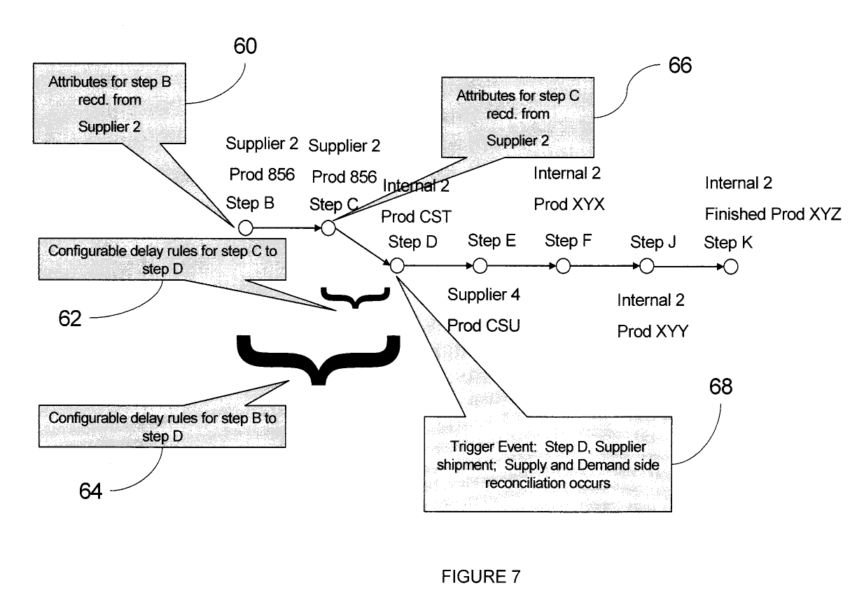

FIGS. 6 and 7 illustrate two examples of trigger events and delay rules and illustrate a portion of the supply chain shown in FIG. 2. More specifically, FIGS. 6 and 7 illustrate steps B-F, J, and K discussed above with respect to FIG. 2. In FIG. 6, item 60 represents the attributes for step B that are received from Supplier 2 and item 66 similarly represents the attributes for step C that are received from Supplier 2. Item 68 represents the trigger event in step D that occurs when Internal 2 ships the component to Supplier 4, and this is when the supply and demand side reconciliations occur. The period represented by item 62 represents the time period when the test results from step C are delayed (they are delayed until Step D). Similarly, item 64 represents the delay of test results from step B to step D.

FIG. 7 illustrates a situation where step E is the trigger point (instead of step D as in FIG. 6). In this situation, item 74 shows that step E is the trigger point and item 70 represents the data that shipment notification is received from supplier 2 at the end of step C. Item 72 represents the delay that it built into the invention where this shipment notification is delayed from step C to step E. The trigger point can also be advanced before the components are actually shipped. For example, the trigger event could actually occur when production of components begins, when the components are partially complete, when the components are being initially or finally tested, when the components are being prepared for shipment, etc. Therefore, the trigger event can be placed forward or backward in time, as necessary.

Thus, as shown above, the invention calculates the supply side reconciliation metrics 512 and raises the supply side reconciliation alerts 514. The invention examines the customer entitlements 520 to identify which data the customer is entitled to see, and then reconciles the trigger (e.g., shipment) to the customer entitlement in the demand side reconciler 522. The demand side reconciliation metrics are calculated and the reconciliation alerts 516 are raised. The invention looks at the supply side and the demand side independently at the trigger event. Trigger events are defined and configured by forward and backward delay windows for reconciliation. While test data is used in the examples shown above, the invention is expandable to any attribute of a manufacturing step, not just test data, such as wafer maps, country of origin, WIP etc.

Some of the benefits which flow from the invention are the ability to verify completeness of data before it is sent to the demand chain. The invention has the ability to intervene and correct data issues prior to transmission to the demand chain. Further, the invention has the ability to shift the diagnosis and remediation closer to the time when data is generated in supply chain than at the point when data is to be sent to the demand chain. The invention also has the potential to analyze and provide timely alternative routing/sourcing when a problem is detected and insulate the supply chain sourcing changes from directly impacting data streams to the demand chain. For example, if a manufacturer allows data to be sent to the demand chain directly from the supply chain, any sourcing (“supplier”) changes made by the manufacturer will require the demand chain to be involved. However, the inventive approach of receiving, integrating, validating and transmitting data insulates the demand chain from any such changes.

Some alternative uses of the invention are the capability of expansion to handle any attribute (physical/chemical/electrical properties, country of origin of components, WIP, etc.) associated with a manufacturing step and in other industries as well. The invention can be easily expanded to work in any environment where requirements exist for tracking information through multiple entities. For example, companies engaged in export/import might be required to collect source information from multiple parties, ensure completeness, and forward to customs and/or other authorities. The retail industry could use similar approach to handle RFID data from its supply chain. A manufacturer could use a similar system to monitor and reconcile RFID data received from its suppliers and RFID data needed by its customers.

While the invention has been described in terms of preferred embodiments, those skilled in the art will recognize that the invention can be practiced with modification within the spirit and scope of the appended claims.

1. A method of integrating data streams across a supply chain and a demand chain, said method comprising:
defining a trigger event;
storing business rules regarding reconciliation spans and exceptions in a database;
performing transformations on said data streams and trigger event data;
performing a supply side reconciliation of said data streams and said trigger event data based on said business rules; and
performing a demand side reconciliation of said data streams and said trigger event data based on said business rules.

2. The method in claim 1, wherein said supply side reconciliation process comprises reconciling said trigger event data with said data streams.

3. The method in claim 1, wherein said trigger event data comprises notification of goods being sent from a point in said supply chain, and wherein and said supply side reconciliation determines whether a data stream associated with said goods is consistent with said notification.

4. The method in claim 1, wherein said demand side reconciliation process comprises determining whether said data streams are complete and whether said data streams were sent to said demand chain.

5. The method in claim 1, wherein said processes of performing said supply side reconciliation and said demand side reconciliation are one of:
selectively delayed a predetermined period after said trigger event; and
selectively advanced a predetermined period before said trigger event.

6. The method in claim 1, wherein said data streams relate to a component of a device being manufactured in said supply chain, and wherein said data streams are supplied one of after said component is completed and during the manufacturing of said component.

7. The method in claim 1, wherein supply side reconciliation and said demand side reconciliation include a process of correcting said data streams.

8. A method of transferring test data from a supply chain to a demand chain, said method comprising:
performing a supply side reconciliation of said test data and a demand side reconciliation of said test data upon the occurrence of a trigger event in said supply chain to produce reconciled data;
processing said reconciled data through a rules database to produce entitled test data; and
verifying that said entitled test data is supplied to selective points in said demand chain.

9. The method in claim 8, wherein said supply side reconciliation process comprises reconciling data from said trigger event with said test data.

10. The method in claim 8, wherein said trigger event comprises notification of goods being sent from a point in said supply chain, and wherein and said supply side reconciliation determines whether test data associated with said goods is consistent with said notification.

11. The method in claim 8, wherein said demand side reconciliation process comprises determining whether said test data is complete.

12. The method in claim 8, wherein said processes of performing said supply side reconciliation and said demand side reconciliation are selectively delayed a predetermined period after said trigger event.

13. The method in claim 8, wherein said entitled test data relates to component test data of a component of a device being manufactured in said supply chain, and wherein said process of supplying said entitled test data supplies said component test data one of after said component is completed and during the manufacturing of said component.

14. The method in claim 8, wherein supply side reconciliation and said demand side reconciliation include a process of correcting said test data.

15. A system for transferring test data from a supply chain to a demand chain, said system comprising:
a trigger event monitor;
a supply side reconciler in communication with said trigger event monitor, and being adapted to perform a supply side reconciliation of said test data upon the occurrence of a trigger event;
a demand side reconciler in communication with said trigger event monitor, and being adapted to perform a demand side reconciliation of said test data upon the occurrence of a trigger event; and
a rules database in communication with said supply side reconciler and said demand side reconciler, and being adapted to produce entitled test data based on said supply side reconciliation and said demand side reconciliation and to verify that the said entitled test data is supplied to selective points in said demand chain.

16. The system in claim 15, wherein said supply side reconciliation process performed by said supply side reconciler comprises reconciling data from said trigger event with said test data.

17. The system in claim 15, wherein said trigger event comprises notification of goods being sent from a point in said supply chain, and wherein and said supply side reconciliation performed by said supply side reconciler determines whether test data associated with said goods is consistent with said notification.

18. The system in claim 15, wherein said demand side reconciliation process performed by said demand side reconciler comprises determining whether said test data is complete.

19. The system in claim 15, wherein said processes of performing said supply side reconciliation and said demand side reconciliation are selectively delayed a predetermined period after said trigger event by said supply side reconciler and said demand side reconciler.

20. The system in claim 15, wherein said entitled test data relates to component test data of a component of a device being manufactured in said supply chain, and wherein said database is adapted to supply said component test data during the processing of said component and before said device is completed.
